(19) United States
(12) Patent Application Publication
(10) Pub. No.: US 2025/0362564 A1
(43) Pub. Date: Nov. 27, 2025

(54) LENS DRIVING DEVICE

(71) Applicant: AAC Microtech (Changzhou) Co., Ltd., Changzhou City (CN)

(72) Inventors: Bo Xiao, Changzhou (CN); Ronglin Linghu, Changzhou (CN); Tong Zhang, Changzhou (CN); Wei Song, Changzhou (CN)

(21) Appl. No.: 19/008,561

(22) Filed: Jan. 2, 2025

Related U.S. Application Data
(63) Continuation of application No. PCT/CN2024/094911, filed on May 23, 2024.

(51) Int. Cl. G03B 5/02; G03B 17/12

(52) U.S. Cl. CPC G03B 5/02; G03B 17/12; G03B 2205/0015; G03B 2205/0069

(57) ABSTRACT

A lens driving device, including: a shell including a bottom plate and an upper cover; a first bracket elastically supported at the bottom plate; a second bracket elastically supported at the first bracket and for mounting a lens assembly; a first driving assembly, two first driving assemblies being provided and configured to drive the lens assembly to move, and the first driving assembly including a first magnetic circuit system fixed to the first bracket and a driving coil fixed to the second bracket; and a second driving assembly configured to drive the second bracket to move, and including a second magnetic circuit system fixed to the bottom plate and an stabilization coil fixed to the first bracket. The lens driving device reduces a risk of falling failure of a barrel of the lens assembly, and suppresses a swinging mode of the barrel of the lens assembly.

### TECHNICAL FIELD

The present disclosure belongs to the technical field of image shooting devices, and in particular, to a lens driving device.

### BACKGROUND

With the improvement of life standards, some devices having image shooting functions (such as digital cameras, digital video cameras, smart phones, tablet computers) already include automatic focusing cameras, and the automatic focusing cameras need to be driven by a lens driving device to realize automatic focusing and optical stabilization.

The lens driving device includes a shell, a first bracket, a second bracket spaced from the first bracket, and a driving assembly configured to drive a lens assembly to move along a direction of an optical axis and along a direction perpendicular to the optical axis. The second bracket is configured to mount the lens assembly, and the driving assembly mainly includes a shared magnetic circuit system, driving coil and stabilization coil.

The magnetic circuit system in the related art is mainly arranged at two pairs of straight edges of the bracket and adopts an open-loop magnetic circuit, while the driving coil is fixed to the second bracket and the stabilization coil is fixed to a bottom plate of the shell. This driving manner using a same open-loop magnetic circuit system can represent ineffective mass when the lens assembly moves.

### SUMMARY

The embodiments of the present disclosure provide a lens driving device, aiming to solve a problem in the related art that a lens driving device uses a driving mode of a same open-loop magnetic circuit system to represent ineffective mass when a lens assembly moves.

The embodiments of the present disclosure provide a lens driving device, including: a shell formed as a rectangular shape, wherein the shell includes a bottom plate and an upper cover covering the bottom plate and cooperating with the bottom plate to enclose a receiving space, and the bottom plate and the upper cover are each provided with a through-hole for making the receiving space in communication with outside; a first bracket formed as a rectangular annular shape and elastically supported at the bottom plate, wherein the first bracket is arranged in the receiving space; a second bracket, wherein the second bracket is elastically supported at an inner side of the first bracket and spaced from the first bracket, and the second bracket is opposite to the through-hole, for mounting a lens assembly; a first driving assembly, wherein two first driving assemblies are provided and arranged at a set of diagonal positions of the first bracket and configured to drive the second bracket to move along a direction of an optical axis of the lens assembly; the first driving assembly includes a first magnetic circuit system fixed to the first bracket and a driving coil fixed to the second bracket; the first magnetic circuit system includes a magnetic yoke fixed to the first bracket, a first magnet assembly stacked at and fixed in the magnetic yoke, and an upper clamping plate stacked at and fixed to an open end of the magnetic yoke; two notches are formed at two opposite sides of the magnetic yoke; the driving coil is arranged around the first magnet assembly and spaced from the first magnet assembly; and the driving coil extends to an outer side of the magnetic yoke via the two notches and is fixedly connected to the second bracket; and a second driving assembly configured to drive the second bracket to move along a direction perpendicular to the optical axis of the lens assembly, wherein the second driving assembly includes a second magnetic circuit system fixed to the bottom plate and an stabilization coil fixed to the first bracket and spaced from the second magnetic circuit system.

As an improvement, the magnetic yoke includes a yoke bottom and a side wall bent and extending from a periphery of the yoke bottom, and the two notches each are formed at the side wall; the first magnet assembly includes a first driving magnet stacked at and fixed to the yoke bottom, a first pole core stacked at and fixed to a side of the first driving magnet away from the yoke bottom, and a second driving magnet stacked at and fixed to a side of the first pole core away from the first driving magnet; and the upper clamping plate is stacked at and fixed to a side of the second driving magnet away from the first pole core.

As an improvement, a set of diagonal positions at an inner periphery of the first bracket are provided with two recesses formed by recessing inward; and magnetic yokes in the two first driving assemblies are fixed in the two recesses.

As an improvement, two second driving assemblies are provided, and stabilization coils in the two second driving assemblies are correspondingly arranged at another set of diagonal positions of the first bracket; the second magnetic circuit system includes two sets of second lower clamping plates fixed at two opposite corner positions of the bottom plate, and two sets of second magnet assemblies stacked at and fixed to sides of the two sets of second lower clamping plates away from the bottom plate.

As an improvement, the second magnet assembly includes a first stabilization magnet, a second stabilization magnet, and a third stabilization magnet that are stacked at and fixed to the second lower clamping plate and sequentially arranged along a direction perpendicular to the optical axis; and the first stabilization magnet, the second stabilization magnet, and the third stabilization magnet are fixedly connected to each other.

As an improvement, the lens driving device further includes a first elastic member, wherein the first elastic member is connected to the first bracket and the bottom plate, and the first elastic member elastically supports the first bracket at the bottom plate.

As an improvement, each second driving assembly includes two stabilization coils that are correspondingly parallel to two sides of a same corner position of the first bracket, the lens driving device further includes a flexible circuit board fixed to a side of the first elastic member away from the first bracket, each stabilization coil in the second driving assembly is electrically connected to the flexible circuit board, and the flexible circuit board passes the first elastic member and extends out of the shell.

As an improvement, the lens driving device further includes an elastic assembly, wherein the elastic assembly is connected to the second bracket and the first bracket, and the elastic assembly elastically supports and suspends the second bracket in the first bracket.

As an improvement, the elastic assembly includes a second elastic member, a third elastic member and a fourth elastic member that spaced from each other; and the second elastic member is connected to a top portion of the second bracket and a top portion of the first bracket, the third elastic member is connected to a middle portion of the second bracket and a middle portion of the first bracket, and the fourth elastic member is connected to a bottom portion of the second bracket and a bottom portion of the first bracket.

As an improvement, four fourth elastic members are provided, and the four fourth elastic members are fixed at four corner positions of the second bracket and the first bracket, respectively.

Compared with the related art, for the lens driving device according to some embodiments of the present disclosure, two first driving assemblies are arranged at a set of diagonal positions of the first bracket, respectively, and two notches are arranged at two opposite sides of the magnetic yoke. The upper clamping plate is fixed to an open end of the magnetic yoke, so that the first magnetic circuit system forms a closed counter top magnetic circuit. Meanwhile, the second magnetic circuit system in the first driving assembly is fixed to the bottom plate, and the stabilization coil thereof is fixed to the first bracket, so that the second magnetic circuit system in the second driving assembly does not participate in the movement of the lens assembly along the direction of the optical axis, thereby reducing a total mass of the movement of the lens assembly along the direction of the optical axis, improving the sensitivity of the first magnetic circuit system to drive the lens assembly to move along the direction of the optical axis, so as to reduce a risk of falling failure of the lens assembly. At the same time, the mass of the stabilization coil can effectively balance the mass of the first magnetic circuit system, and can further suppress a swing mode of the lens assembly on the premise of reducing the total mass of the lens assembly.

### BRIEF DESCRIPTION OF DRAWINGS

In order to better illustrate embodiments of the present disclosure or the technical solutions in the related art, the drawings required to be used in the description of the embodiments will be briefly described below. Obviously, the drawings in the following descriptions are merely some embodiments of the present disclosure, and other drawings may be obtained by those skilled in the art according to these drawings without paying any creative efforts.

FIG. 1 is a schematic diagram of an overall structure of a lens driving device according to an embodiment of the present disclosure;

FIG. 2 is an exploded view of a lens driving device according to an embodiment of the present disclosure;

FIG. 3 is a sectional view along A-A shown in FIG. 1; and

FIG. 4 is a sectional view along B-B shown in FIG. 1.

Reference signs:

100. lens driving device;
1. shell;
10. through-hole;
11. bottom plate;
12. upper cover;
2. first bracket;
21. recess;
3. second bracket;
4. lens assembly;
5. first driving assembly;
51. first magnetic circuit system;
511. magnetic yoke;
5111. yoke bottom;
5112. side wall;
512. first magnet assembly;
5121. first driving magnet;
5122. first pole core;
5123. second driving magnet;
513. upper clamping plate;
52. driving coil;
6. second driving assembly;
61. second magnetic circuit system;
611. second lower clamping plate;
612. second magnet assembly;
6121. first stabilization magnet;
6122. second stabilization magnet;
6123. third stabilization magnet;
62. stabilization coil;
7. first elastic member;
8. flexible circuit board;
9. elastic assembly;
91. second elastic member;
92. third elastic member;
921. connection member;
93. fourth elastic member.

### DESCRIPTION OF EMBODIMENTS

In order to better illustrate the objectives, technical solutions, and advantages of the present disclosure, the present disclosure is described in details below with reference to the accompanying drawings and embodiments. It should be understood that specific embodiments described herein are intended only to interpret the present disclosure and not to limit the present disclosure.

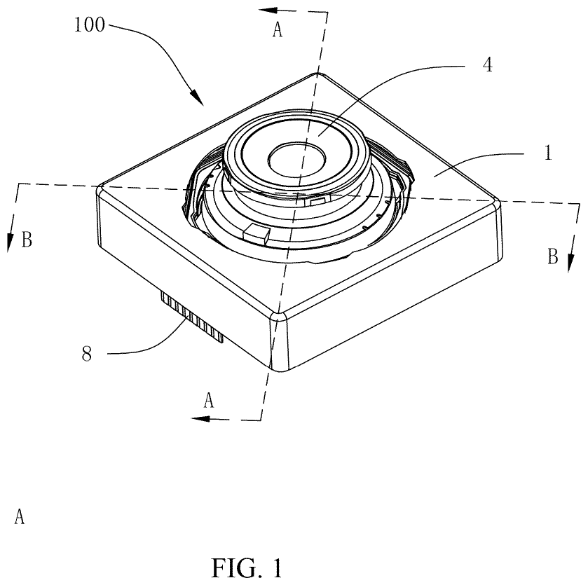

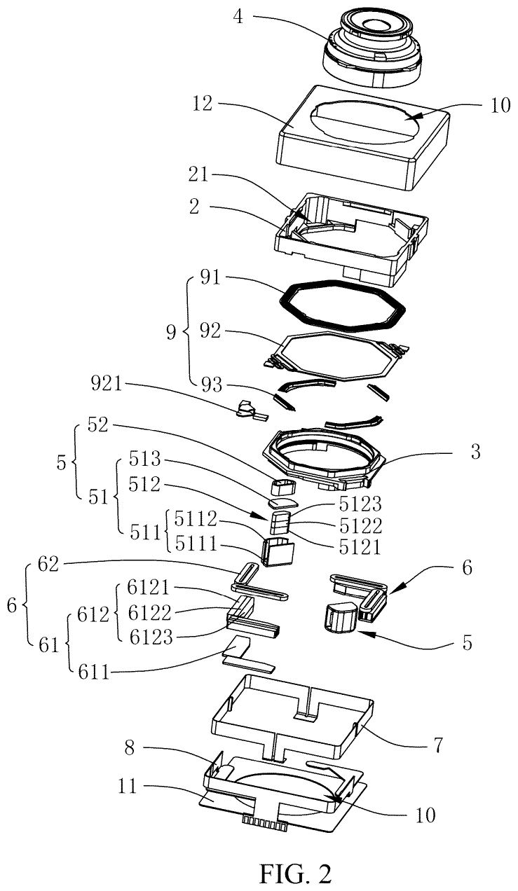

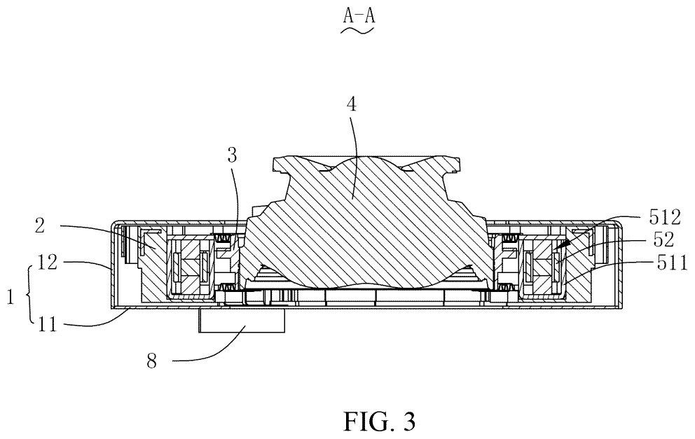

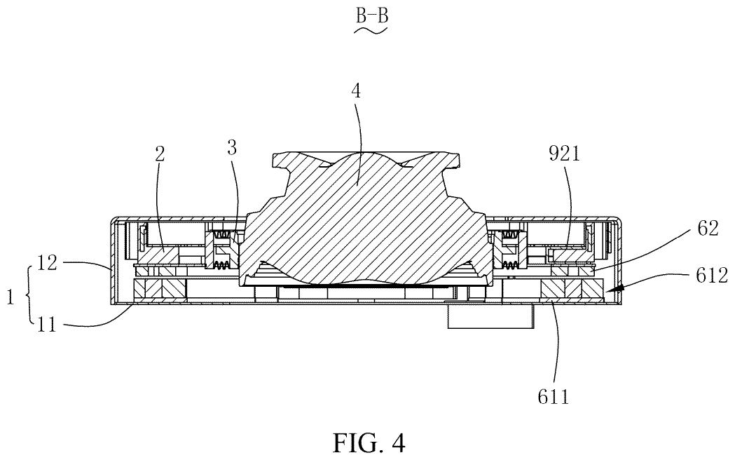

Some embodiments of the present disclosure provide a lens driving device 100, as shown in FIG. 1 to FIG. 4, including a shell 1, a first bracket 2, a second bracket 3, a first driving assembly 5, and a second driving assembly 6.

The shell 1 is formed as a rectangular shape, and the shell 1 includes a bottom plate 11 and an upper cover 12 covering the bottom plate 11 and cooperate with the bottom plate 11 to enclose a receiving space. The bottom plate 11 and the upper cover 12 each are provided with a through-hole 10 for make the receiving space in communication with outside. The first bracket 2 is formed as a rectangular annular shape and elastically supported at the bottom plate 11, and the first bracket is arranged in the receiving space. The second bracket 3, further referred to as a lens barrel, is formed as an annular shape and elastically supported at an inner side of the first bracket 2. The second bracket 3 is spaced from the first bracket 2, and the second bracket 3 is opposite to the through-hole 10, for mounting the lens assembly 4.

A set of diagonal positions at an inner periphery of the first bracket 2 are provided with two recesses 21 formed by recessing inward, respectively.

In an example, the first driving assembly 5 includes a first magnetic circuit system 51 fixed to the first bracket 2 and a driving coil 52 fixed to the second bracket 3.

The first magnetic circuit system 51 includes a magnetic yoke 511 fixed to the first bracket 2, a first magnet assembly 512 stacked at and fixed to the magnetic yoke 511, and an upper clamping plate 513 stacked at and fixed to an open end of the magnetic yoke 511. Two notches are formed at two opposite sides of the magnetic yoke 511. The driving coil 52 is arranged around the first magnet assembly 512 and spaced from the first magnet assembly 512, and the driving coil 52 extends to an outer side of the magnetic yoke 511 via the two notches and is fixedly connected to the second bracket 3.

The magnetic yoke 511 includes a yoke bottom 5111 and a side wall 5112 formed by bending and extending a periphery of the yoke bottom 5111.

The first magnet assembly 512 includes a first driving magnet 5121 stacked at and fixed to the magnetic yoke 511, a first pole core 5122 stacked at and fixed to a side of the first driving magnet 5121 away from the magnetic yoke 511, and a second driving magnet 5123 stacked at and fixed to a side of the first pole core 5122 away from the first driving magnet 5121. The upper clamping plate 513 is stacked at and fixed to a side of the second driving magnet 5123 away from the first pole core 5122.

Two first driving assemblies 5 are correspondingly arranged at a set of diagonal positions of the first bracket 2, respectively. The magnetic yokes 511 of the two first driving assemblies 5 are fixed in the two recesses 21, respectively. The two first driving assemblies 5 are configured to drive the second bracket 3 to move along a direction of an optical axis of the lens assembly 4.

In an example, the second driving assembly 6 is configured to drive the second bracket 3 to move along a direction perpendicular to the optical axis of the lens assembly 4. The second driving assembly 6 includes a second magnetic circuit system 61 fixed to the bottom plate 11, and an stabilization coil 62 fixed to the first bracket 2 and spaced from the second magnetic circuit system 61.

Two second driving assemblies 6 are provided, and the stabilization coils 62 of the two second driving assemblies 6 are correspondingly arranged at another set of diagonal positions of the first bracket 2, respectively. The second magnetic circuit system 61 includes two sets of second lower clamping plates 611 fixed at two opposite corner positions of the bottom plate 11, and two sets of second magnet assemblies 612 stacked at and fixed to sides of the two sets of second lower clamping plates 611 away from the bottom plate 11, respectively.

Each set of second lower clamping plates 611 includes two second lower clamping plates 611, and the two second lower clamping plates 611 are parallel to two adjacent sides of the bottom plate 11, respectively, that is, two sides forming corner positions of the bottom plate 11, respectively.

The second magnet assembly 612 includes a first stabilization magnet 6121, a second stabilization magnet 6122, and a third stabilization magnet 6123 that are stacked at and fixed to the second lower clamping plate 611 and sequentially arranged along a direction perpendicular to the optical axis. The first stabilization magnet 6121, the second stabilization magnet 6122, and the third stabilization magnet 6123 are fixedly connected to each other.

In an example, the lens driving device 100 further includes a first elastic member 7. The first elastic member 7 is connected to the first bracket 2 and the bottom plate 11, respectively, and the first elastic member 7 elastically supports and suspends the first bracket 2 at the bottom plate 11.

For example, each second driving assembly 6 includes two stabilization coils 62 that are correspondingly parallel to two sides of a same corner position of the first bracket 2, respectively, and the two stabilization coils 62 are opposite to and spaced from two second magnet assemblies 612 of a same set, respectively. The lens driving device 100 further includes a flexible circuit board 8 fixed to a side of the first elastic member 7 away from the first bracket 2. All the stabilization coils 62 of the second driving assembly 6 are electrically connected to the flexible circuit board 8, and the flexible circuit board 8 passes the bottom plate 11 and extends out of the shell 1.

In an example, the lens driving device 100 further includes an elastic assembly 9. The elastic assembly 9 is connected to the second bracket 3 and the first bracket 2, respectively, and the elastic assembly 9 is elastically supports and suspends the second bracket 3 in the first bracket 2.

The elastic assembly 9 includes a second elastic member 91, a third elastic member 92, and a fourth elastic member 93 that are spaced from each other. The second elastic member 91 is connected to a top portion of the second bracket 3 and a top portion of the first bracket 2, the third elastic member 92 is connected to a middle portion of the second bracket 3 and a middle portion of the first bracket 2, and the fourth elastic member 93 is connected to a bottom portion of the second bracket 3 and a bottom portion of the first bracket 2. That is, the second bracket 3 is elastically supported at the first bracket 2 by the second elastic member 91, the third elastic member 92 and the fourth elastic member 93.

The second elastic member 91 is formed as an annular and wavy shape. The third elastic member 92 includes a first fixation arm that is formed as an annular shape and fixed to the second bracket 3, two elastic arms formed by bending and extending two opposite ends of the first fixation arm, and a second fixation arm formed by extending an end of each of the two elastic arms away from the first fixation arm. The second fixation arm is fixed to the first bracket 2. Four fourth elastic members 93 are provided, and the four fourth elastic members 93 are spaced form one another and formed as a wavy shape.

The third elastic member 92 is connected to the flexible circuit board 8 through a connection member 921 fixed to the first bracket 2, and the third elastic member 92 is an elastic circuit board and is electrically connected to two driving coils 52 of the first driving assembly 5, to achieving an electrical connection between the driving coil 52 and the flexible circuit board 8.

Four fourth elastic members 93 are provided and fixed at four corner positions of the second bracket 3 and the first bracket 2, respectively.

For the lens driving device 100 according to some embodiments of the present disclosure, two first driving assemblies 5 are arranged at a set of diagonal positions of the first bracket 2, respectively, and two notches are arranged at two opposite sides of the magnetic yoke 511. The upper clamping plate 513 is fixed to an open end of the magnetic yoke 511, so that the first magnetic circuit system 51 forms a closed counter top magnetic circuit. Meanwhile, the second magnetic circuit system 61 in the first driving assembly 5 is fixed to the bottom plate 11, and the stabilization coil 62 thereof is fixed to the first bracket 2, so that the second magnetic circuit system 61 in the second driving assembly 6 does not participate in the movement of the lens assembly 4 along the direction of the optical axis, thereby reducing a total mass of the movement of the lens assembly 4 along the direction of the optical axis, improving the sensitivity of the first magnetic circuit system 51 to drive the lens assembly 4 to move along the direction of the optical axis, so as to reduce a risk of falling failure of the lens assembly 4. At the same time, the mass of the stabilization coil 62 can effectively balance the mass of the first magnetic circuit system 51, and can further suppress a swing mode of the lens assembly 4 on the premise of reducing the total mass of the lens assembly 4.

The above description merely illustrates some preferred embodiments of the present disclosure and is not intended to limit the present disclosure, and any modifications, equivalent substitutions and improvements and the like made within a spirit and principle of the present disclosure shall fall within a scope of the present disclosure.

What is claimed is:

1. A lens driving device, comprising:
a shell formed as a rectangular shape, wherein the shell comprises a bottom plate and an upper cover covering the bottom plate and cooperating with the bottom plate to enclose a receiving space, and the bottom plate and the upper cover are each provided with a through-hole for making the receiving space in communication with outside;
a first bracket formed as a rectangular annular shape and elastically supported at the bottom plate, wherein the first bracket is arranged in the receiving space;
a second bracket, wherein the second bracket is elastically supported at an inner side of the first bracket and spaced from the first bracket, and the second bracket is opposite to the through-hole, for mounting a lens assembly;
a first driving assembly, wherein two first driving assemblies are provided and arranged at a set of diagonal positions of the first bracket and configured to drive the second bracket to move along a direction of an optical axis of the lens assembly; the first driving assembly comprises a first magnetic circuit system fixed to the first bracket and a driving coil fixed to the second bracket; the first magnetic circuit system comprises a magnetic yoke fixed to the first bracket, a first magnet assembly stacked at and fixed in the magnetic yoke, and an upper clamping plate stacked at and fixed to an open end of the magnetic yoke; two notches are formed at two opposite sides of the magnetic yoke; the driving coil is arranged around the first magnet assembly and spaced from the first magnet assembly; and the driving coil extends to an outer side of the magnetic yoke via the two notches and is fixedly connected to the second bracket; and
a second driving assembly configured to drive the second bracket to move along a direction perpendicular to the optical axis of the lens assembly, wherein the second driving assembly comprises a second magnetic circuit system fixed to the bottom plate and an stabilization coil fixed to the first bracket and spaced from the second magnetic circuit system.

2. The lens driving device as described in claim 1, wherein the magnetic yoke comprises a yoke bottom and a side wall bent and extending from a periphery of the yoke bottom, and the two notches each are formed at the side wall; the first magnet assembly comprises a first driving magnet stacked at and fixed to the yoke bottom, a first pole core stacked at and fixed to a side of the first driving magnet away from the yoke bottom, and a second driving magnet stacked at and fixed to a side of the first pole core away from the first driving magnet; and the upper clamping plate is stacked at and fixed to a side of the second driving magnet away from the first pole core.

3. The lens driving device as described in claim 1, wherein a set of diagonal positions at an inner periphery of the first bracket are provided with two recesses formed by recessing inward; and magnetic yokes in the two first driving assemblies are fixed in the two recesses.

4. The lens driving device as described in claim 1, wherein two second driving assemblies are provided, and stabilization coils in the two second driving assemblies are correspondingly arranged at another set of diagonal positions of the first bracket; the second magnetic circuit system comprises two sets of second lower clamping plates fixed at two opposite corner positions of the bottom plate, and two sets of second magnet assemblies stacked at and fixed to sides of the two sets of second lower clamping plates away from the bottom plate.

5. The lens driving device as described in claim 4, wherein the second magnet assembly comprises a first stabilization magnet, a second stabilization magnet, and a third stabilization magnet that are stacked at and fixed to the second lower clamping plate and sequentially arranged along a direction perpendicular to the optical axis; and the first stabilization magnet, the second stabilization magnet, and the third stabilization magnet are fixedly connected to each other.

6. The lens driving device as described in claim 1, further comprising a first elastic member, wherein the first elastic member is connected to the first bracket and the bottom plate, and the first elastic member elastically supports the first bracket at the bottom plate.

7. The lens driving device as described in claim 6, wherein each second driving assembly comprises two stabilization coils that are correspondingly parallel to two sides of a same corner position of the first bracket, the lens driving device further comprises a flexible circuit board fixed to a side of the first elastic member away from the first bracket, each stabilization coil in the second driving assembly is electrically connected to the flexible circuit board, and the flexible circuit board passes the first elastic member and extends out of the shell.

8. The lens driving device as described in claim 1, further comprising an elastic assembly, wherein the elastic assembly is connected to the second bracket and the first bracket, and the elastic assembly elastically supports and suspends the second bracket in the first bracket.

9. The lens driving device as described in claim 8, wherein the elastic assembly comprises a second elastic member, a third elastic member and a fourth elastic member that spaced from each other; and the second elastic member is connected to a top portion of the second bracket and a top portion of the first bracket, the third elastic member is connected to a middle portion of the second bracket and a middle portion of the first bracket, and the fourth elastic member is connected to a bottom portion of the second bracket and a bottom portion of the first bracket.

10. The lens driving device as described in claim 9, wherein four fourth elastic members are provided, and the four fourth elastic members are fixed at four corner positions of the second bracket and the first bracket, respectively.
